(19) United States
(12) Patent Application Publication
(10) Pub. No.: US 2018/0046025 A1
(43) Pub. Date: Feb. 15, 2018

(54) Method and Device for Modulating Backlight Source, Light Bar, Backlight Module, and Display Device

(71) Applicants: BOE Technology Group Co., Ltd., Beijing (CN); Beijing BOE Optoelectronics Technology Co., Ltd., Beijing (CN)

(72) Inventors: Yingming Liu, Beijing (CN); Xue Dong, Beijing (CN); Xiaochuan Chen, Beijing (CN); Haisheng Wang, Beijing (CN); Xiaoliang Ding, Beijing (CN); Shengji Yang, Beijing (CN); Weijie Zhao, Beijing (CN); Changfeng Li, Beijing (CN); Wei Liu, Beijing (CN); Pengpeng Wang, Beijing (CN); Liguang Deng, Beijing (CN); Huizhong Zhu, Beijing (CN)

(73) Assignees: BOE Technology Group Co., Ltd., Beijing (CN); Beijing BOE Optoelectronics Technology Co., Ltd., Beijing (CN)

(21) Appl. No.: 15/529,804

(22) PCT Filed: Oct. 24, 2016
(86) PCT No.: PCT/CN2016/103002

§ 371 Date: May 25, 2017

(30) Foreign Application Priority Data
Jan. 4, 2016 (CN) 201610005446.2

(51) Int. Cl. G02F 1/1335; G06K 9/00; F21S 4/28; G09G 3/34

(52) U.S. Cl. CPC G02F 1/133602; G09G 3/34; G06K 9/00087; F21S 4/28

(57) ABSTRACT

A method and device for modulating a backlight source, a light bar, a backlight module, a display device, which can reduce the noise output from the backlight source. The method for modulating the backlight source includes inputting a periodic AC voltage to the backlight source within a time period of an image frame, so that the backlight source is periodically turned on and off. The display device may have a fingerprint or palmprint recognition function.

### TECHNICAL FIELD

The embodiments of present disclosure relates to a method and a device for modulating a backlight source, a light bar, a backlight module and a display device.

### BACKGROUND

With the continuous improvement of living standards, mobile phones, computers and other display devices become necessities of life. Although a great variety of display devices are presented in the current market, the consumers are still pursuing display devices having better performance, higher security, and novel and unique appearance.

For example, the security of electronic products can be achieved mainly through the fingerprint or palmprint recognition function. Because each person's fingerprints or palmprints are not the same, that is, the fingerprint or palmprint is of uniqueness and is kept unchanged all one's life, thus is used for security verification.

### SUMMARY

The embodiments of present disclosure provides a method and device for modulating the backlight source, a light bar, a backlight module, a display device, which can reduce the noise output from backlight.

In a first aspect, an embodiment of the present disclosure provides a method for modulating a backlight source, comprising: inputting a periodic AC voltage to the backlight source within the time period of an image frame, so that the backlight source is periodically turned on and off.

For example, in the method for modulating the backlight source, the time period of an image frame comprises a first time phase and a second time phase, and the method further comprises: in the first time phase, inputting the periodic AC voltage to the backlight source; in the second time phase, inputting a constant voltage to the backlight source so as to turn off the backlight source.

For example, in the method for modulating the backlight source, the periodic AC voltage comprises a pulse voltage or a sinusoidal voltage.

For example, in the method for modulating the backlight source, the pulse voltage comprises a square-wave pulse voltage or a saw-tooth pulse voltage.

In a second aspect, an embodiment of the present disclosure provides a device for modulating a backlight source, comprising a voltage generation module and a control module; the voltage generation module is configured to generate a periodic AC voltage within a time period of an image frame; the control module is configured to input the AC voltage generated by the voltage generation module into the backlight source, in order to control the backlight source to be periodically turned on and off.

For example, in the device, the time period of an image frame comprises a first time phase and a second time phase; the voltage generation module is configured to generate the periodic AC voltage in the first time phase, and to generate a constant voltage in the second time phase, in order to turn off the backlight source.

For example, in the device, the periodic AC voltage comprises a pulse voltage or a sinusoidal voltage.

In a third aspect, an embodiment of the present disclosure provides a light bar comprising: a circuit board; a backlight source provided on the circuit board; and the device for modulating a backlight source of the second aspect; the device for modulating the backlight source is integrally provided onto the circuit board.

In a fourth aspect, an embodiment of the present disclosure provides a backlight module comprising the light bar of the third aspect.

In a fifth aspect, an embodiment of the present disclosure provides a display device comprising a liquid crystal display panel and a backlight module that is the backlight module of the fourth aspect; the liquid crystal display panel comprises a fingerprint or palmprint recognition unit integrated in the sub-pixels; and the fingerprint or palmprint recognition unit comprises a photosensitive device.

For example, in the display device, a touch sensing structure is further included.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1a is a schematic view of a driving voltage inputted to a backlight source;

FIG. 1b is a schematic view of the driving voltage and noise inputted to the backlight source;

FIG. 2a is a first schematic view of the driving voltage inputted to the backlight source provided by an embodiment of present disclosure;

FIG. 2b is a first schematic view of the driving voltage and noise inputted to the backlight source provided by an embodiment of present disclosure;

FIG. 3a is a second schematic view of the driving voltage inputted to the backlight source provided by an embodiment of present disclosure;

FIG. 3b is a second schematic view of the driving voltage and noise inputted to the backlight source provided by an embodiment of present disclosure;

FIG. 4a is a third schematic view of the driving voltage inputted to the backlight source provided by an embodiment of present disclosure;

FIG. 4b is a third schematic view of the driving voltage and noise inputted to the backlight source provided by an embodiment of present disclosure;

FIG. 5 is a fourth schematic view of the driving voltage inputted to the backlight source provided by an embodiment of present disclosure;

FIG. 6 is a fifth schematic view of the driving voltage inputted to the backlight source provided by an embodiment of present disclosure;

FIG. 7 is a sixth schematic view of the driving voltage inputted to the backlight source provided by an embodiment of present disclosure;

FIG. 8 is a schematic view of a device for modulating the backlight source provided by an embodiment of present disclosure;

FIG. 9 is a schematic view of a light bar provided by an embodiment of present disclosure;

FIG. 10 is a schematic view of a backlight module provided by an embodiment of present disclosure;

FIG. 11 is a schematic view of a display device provided by an embodiment of present disclosure; and

FIG. 12 is a schematic view of an array substrate provided by an embodiment of present disclosure.

### REFERENCE NUMERALS

10—device for modulating a backlight source; 101—voltage generation module; 102—control module; 20—circuit board; 30—backlight; 40—light bar; 50—light guide plate; 60—reflector sheet; 70—optical film; 100—backlight module; 200—liquid crystal display panel; 210—array substrate; 211—sub-pixel; 211a—display unit; 211b—fingerprint or palmprint recognition unit; 220—cell-assembling substrate; 230—liquid crystal layer; 240—lower polarizer sheet; 250—upper polarizer sheet; 300—OCA; 400—safety glass; SL—scan line; DL—data line.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

The inventors of the present application propose to provide a photosensitive device in a display device to achieve the identification of a fingerprint or a palmprint, and the principle thereof is described as follows. With the refraction and reflection principle of light, when a finger or a palm touches a screen surface, light emitted from a light source irradiates the valley lines and ridge lines of the finger or palm, then due to the difference between the valley lines and ridge lines in the reflection angle and the intensity of reflected light, the light projected onto the photosensitive device can produce different electrical currents, so that the valley lines and ridge lines of the finger or palm can be recognized.

In a liquid crystal display device, the light emitted from a backlight source, such as a light emitting diode (LED), of the backlight module falls into the visible light band, its luminous intensity is based on the input voltage. During the period of the liquid crystal display device displaying a frame of image, that is, within the time period T of an image frame, the voltage for driving an LED is as illustrated in FIG. 1a. However, indefinite noise signals are introduced due to the reasons from the outer environment or the device itself, such noise signals can be inputted to the LED along with the driving voltage, and will also bring about corresponding light component which is outputted together with the visible light initiated by the driving voltage itself for the LED. Because the fingerprint identification relies on the light emitted from the LED, accordingly and as illustrated in FIG. 1b, during the recognition process, in addition to fact that the light is emitted from the LED due to the driving voltage inputted thereto is incident onto the valley lines and ridge lines and then the light is projected onto the photosensitive device produces electrical currents, the light emitted from LED due to the above-mentioned noise signals being inputted thereto is also incident onto the valley lines and ridge lines and then is projected onto the photosensitive device so that corresponding electrical currents is produced, which consequently causes fluctuation (i.e., noise) of the currents during the recognition process, which in turn causes difficulty in recognition.

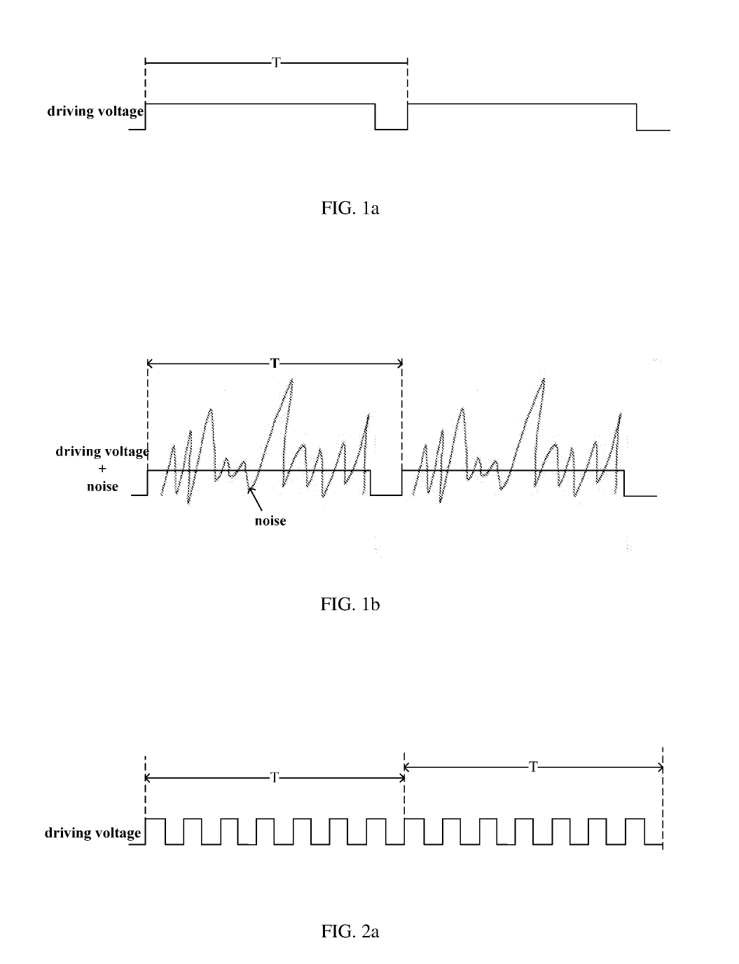

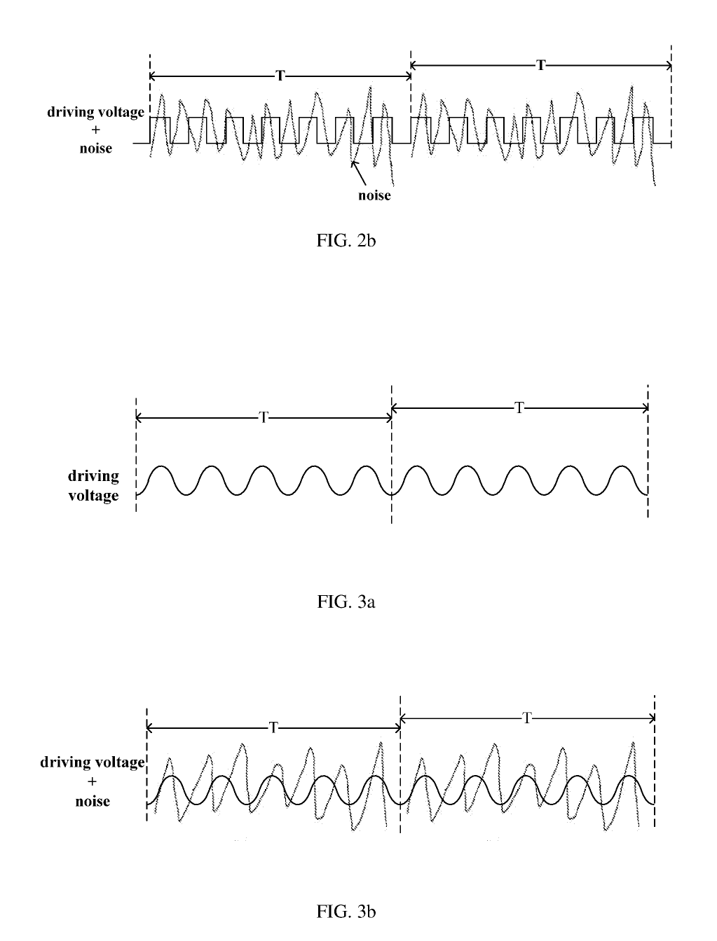

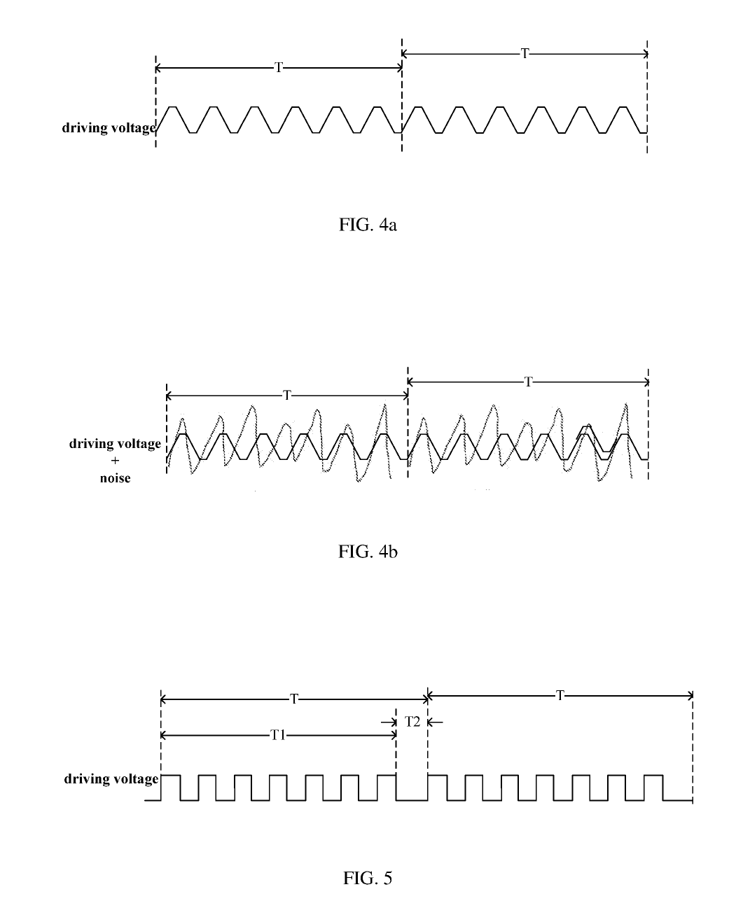

An embodiment of present disclosure provides a method for modulating the backlight source, as illustrated in FIGS. 2a, 3a and 4a, a periodic AC voltage is inputted to the backlight source within a time period T of an image frame, so that the backlight source is periodically turned on and off.

It should be noted that, first, the embodiments of present disclosure have no restriction on the period of the periodic AC voltage inputted to the backlight source within the time period T of an image frame, that is, have no limitation on the frequency of the AC voltage inputted within the time period T of an image frame.

In the embodiments of present disclosure, the voltage, which is repeatedly changed once each time after a certain time within the time period of an image frame, is called a periodic AC voltage.

It will be appreciated by those skilled in this art that, although the noise inputted into the backlight source is indefinite, however, when the frequency of AC voltage inputted into the backlight source in the time period T of an image frame changes, the noise outputted from the backlight source is also different. Based on this, for example, the frequency of the AC voltage inputted to the backlight source may be selected in such a way that the backlight source output noise is minimum.

That is to say, as illustrated in FIGS. 2b, 3b and 4b, by adjusting the frequency of the AC voltage in the time period T of an image frame, it is possible to make a part of the noise be filtered out when the backlight source is turned off, and only less noise is outputted from the backlight source when the backlight source is turned on.

Second, in an embodiment of present disclosure, the type of the AC voltage is such that the backlight source can be at least turned on and off in one period.

Due to the characteristics of human eyes, when the backlight source is turned off, the human eye's vision is still able to feel the brightness of light for a certain time (which may be more than 20 ms), therefore, when the backlight source is in its turned-off state, the state of turning-off is invisible to human eyes.

Third, in an embodiment of present disclosure, as to the maximal value and the minimum value of the AC voltage, these values can be determined based on the time at which the backlight source is turned on and off in one period.

According to the type of the backlight source, when the voltage inputted to the backlight source is greater than or equal to its turn-on threshold voltage, the backlight source is turned on, and when the voltage inputted to the backlight source is less than its turn-on threshold voltage, the backlight source is turned off.

Fourth, the backlight source in the embodiment of present disclosure may be an LED backlight source, for example, may also be another type of backlight sources with better performance than LED.

Compared with the cases in which, in the time period T of an image frame, the voltage inputted to the backlight source has no periodic variation and a high level is continuously inputted for the whole period in order to turn on the backlight source, the method for modulating the backlight source provided by an embodiment of present disclosure requires to input a periodic AC voltage to the backlight source in the time period T of an image frame, and to control the frequency of the AC voltage inputted during such a time period T, in such a way that the noise outputted from the backlight source is reduced, and thus it is possible to depress the current fluctuation caused by the noise in the recognition process for the valley lines and ridge lines, and to improve the accuracy for the recognition of the fingerprint or palmprint.

For example, as illustrated in FIGS. 5, 6 and 7, the time period T of an image frame comprises a first time phase T1 and a second time phase T2.

Based on this, a periodic AC voltage is inputted to the backlight source in the time period T of an image frame, wherein a periodic AC voltage is inputted to the backlight source in the first time phase T1; and a constant voltage is inputted to the backlight source in the second time phase T2 so as to turn off the backlight.

In an embodiment of present disclosure, by regulating the durations of the first time phase T1 and the second time phase T2 of the time period T of an image frame, it is possible to adjust the brightness value of the light emitted from the backlight source. Based on this, different brightness values correspond to different brightness levels, and therefore, when the backlight source of the embodiment of present disclosure is applied to a display device, the brightness level of the backlight source can also correspond to different gray scale values. Therefore, by regulating the durations of the above first time phase T1 and second time phase T2, it is possible to achieve an adjustment of the gray scale of the display device.

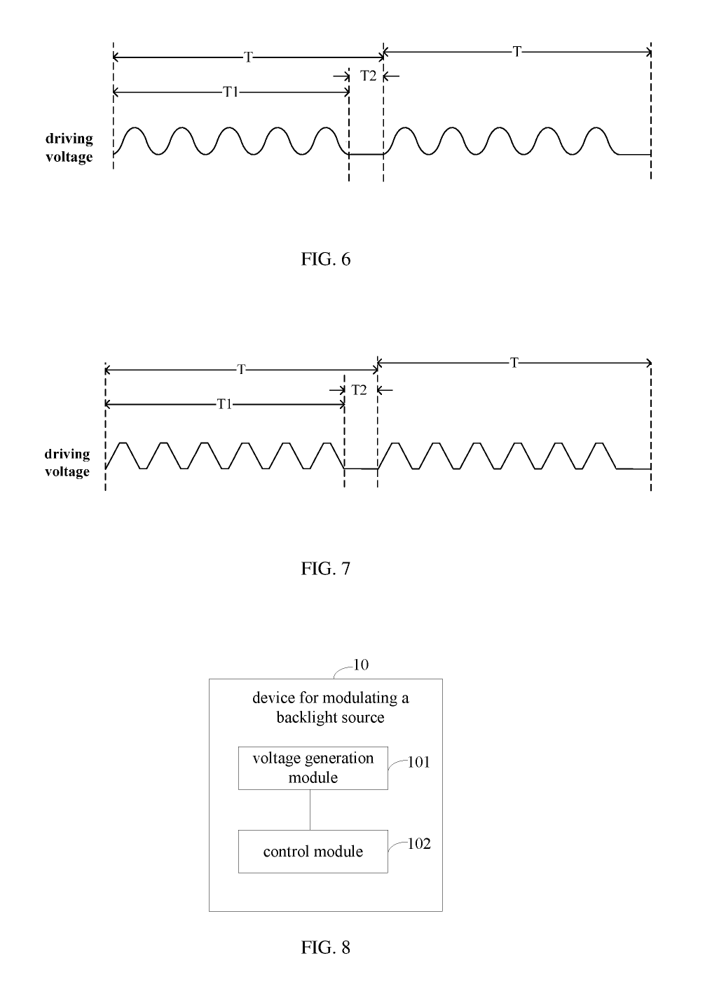

For example, the periodic AC voltage may be a pulse voltage as illustrated in FIGS. 5 and 7, or a sinusoidal voltage as illustrated in FIG. 6.

Further, the pulse voltage may be a square-wave pulse voltage as illustrated in FIG. 5, or alternatively, the pulse voltage may be a saw-tooth pulse voltage as illustrated in FIG. 7.

In the case where the square-wave pulse voltage is employed, the duty cycle of the square-wave can be properly regulated in order that the noise outputted from the backlight source becomes minimum, and the luminous performance gets better.

As an example, the duty cycle of the above square-wave may be 50%, 60% or the like.

When the saw-tooth pulse voltage is employed, it may further be a triangular wave pulse voltage.

An embodiment of present disclosure also provides a device 10 for modulating the backlight source, and as illustrated in FIG. 8, the device for modulating the backlight comprises a voltage generation module 101 and a control module 102.

As illustrated in FIGS. 2a, 3a and 4a, the voltage generation module 101 is used to generate a periodic AC voltage within the time period of an image frame. Such a voltage generation module 101 may be for example an AC signal generation circuit.

The control module 102 is used to input the AC voltage generated by the voltage generation module 101 into the backlight source, in order to control the backlight source to be periodically turned on and off. The control module 102 may be a switching circuit, a control chip or the like, for example.

Based on this, as illustrated in FIGS. 2b, 3b and 4b, by regulating the frequency of the AC voltage generated by the voltage generation module 101 in the time period T of an image frame, most of the noise can be filtered out while the backlight source is turned off, but only less of the noise is outputted from the backlight source when the backlight source is turned on.

Compared with the cases in which, in the time period T of an image frame, the voltage inputted to the backlight source has no periodic variation and a high level is continuously inputted for the whole period in order to turn on the backlight source, the device 10 for modulating the backlight source provided by an embodiment of present disclosure uses the control module 102 so that the periodic AC voltage generated by the voltage generation module 101, in the time period T of an image frame, is inputted to the backlight source, and that the frequency of the AC voltage generated during such a time period T is regulated, in such a way that the noise outputted from the backlight source is reduced, and thus it is possible to depress the current fluctuation caused by the noise in the recognition process for the valley lines and ridge lines, and to improve the accuracy for the recognition of the fingerprint or palmprint.

For example, the time period T of an image frame comprises a first time phase T1 and a second time phase T2, and based on this, as illustrated in FIGS. 5, 6 and 7, the voltage generation module 101 generates a periodic AC voltage in the first time phase T1; and the voltage generation module 101 generates a constant voltage in the second time phase T2 so as to turn off the backlight source. The time period T of an image frame may only comprise the above-mentioned first time phase T1 and second time phase T2, and as required, it may also further comprise other time period(s), in which, a constant voltage may be provided to turn on the backlight, for example.

In an embodiment of present disclosure, by regulating the durations of the first time phase T1 and the second time phase T2 of the time period T of an image frame, it is possible to adjust the brightness value of the light emitted from the backlight source. Based on this, different brightness values correspond to different brightness levels, and therefore, when the backlight source of the embodiment of present disclosure is applied to a display device, the brightness level of the backlight source may also correspond to different gray scale values. Therefore, by regulating the durations of the above first time phase T1 and second time phase T2, it is possible to achieve an adjustment of the gray scale of the display device.

For example, the periodic AC voltage may be a pulse voltage as illustrated in FIGS. 5 and 7, or a sinusoidal voltage as illustrated in FIG. 6.

The pulse voltage may be a square-wave pulse voltage, or alternatively and as illustrated in FIG. 7, the pulse voltage may be a saw-tooth pulse voltage.

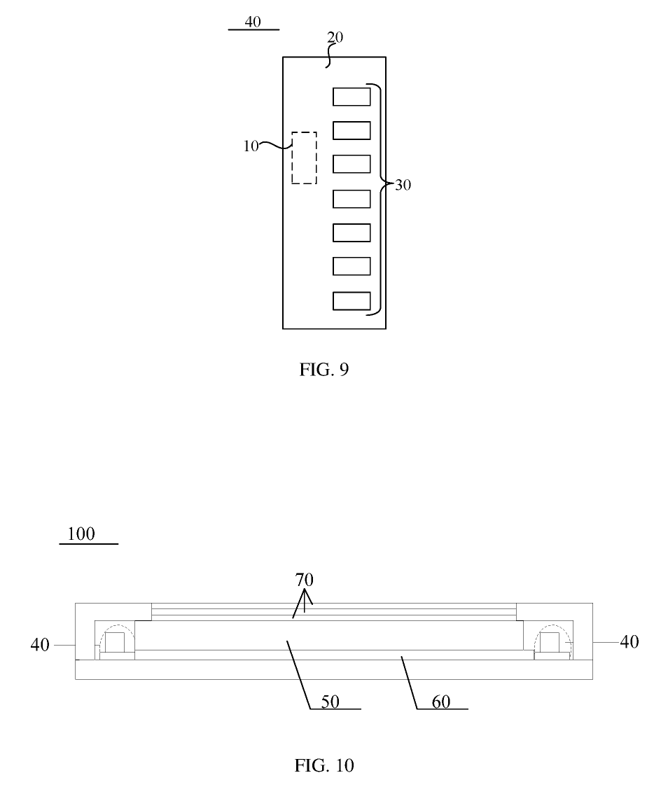

An embodiment of present disclosure also provides a light bar (a light component) 40, which, as illustrated in FIG. 9, comprises a circuit board 20 and a backlight sources 30 arranged on the circuit board 20, and which further comprises the above-described device 10 for modulating the backlight source; the device 10 for modulating the backlight source may be integrated into or amounted onto the circuit board 20.

It should be noted that, first, the backlight sources 30 may be arranged in a certain direction spaced apart from each other, for example, in an equal interval arrangement, or alternatively, the backlight sources 30 is divided into sets of arrangements, each of the sets can have the backlight sources 30 thereof to be arranged at an equal interval.

Second, the device 10 for modulating the backlight source, integrated onto the circuit board 20, is in electrical connection with the backlight source 30. The circuit board 20 may be for example a printed circuit board (PCB), and it may also be a flexible printed circuit (FPC).

In the case where the light bar 40 provided by an embodiment of present disclosure is applied to a display device, because the noise outputted from the backlight can be reduced, thus it is possible to depress the current fluctuation caused by the noise in the recognition process of the valley lines and ridge lines, and to improve the accuracy of recognition of the fingerprint or palmprint.

Preferably, because LED has advantages, such as compactness, low power consumption, and long service life, it is preferable that all of the backlight sources 30 are LEDs.

An embodiment of present disclosure also provides a backlight module 100, which comprises the above light bar 40, as illustrated in FIG. 10.

Further, the backlight module 100 may further comprise a light guide plate 50 and an optical film 70, as illustrated in FIG. 10. The backlight module 100 may further comprise a reflector sheet 60.

It should be noted that, in the display device illustrated in FIG. 10, the light bars 10 are provided at both lateral sides of the light guide plate 50, that is, the backlight module is a side-lighting type backlight module, however, the embodiments of present disclosure are not limited thereto, but the backlight module may also be a direct-lighting type backlight module, that is, the light bars 10 may be provided below the light guide plate 50.

When the backlight module 100 provided by an embodiment of present disclosure is applied to a display device, because the noise outputted from the backlight can be reduced, it is thus possible to depress the current fluctuation caused by the noise in the recognition process of the valley lines and ridge lines, and to improve the accuracy of recognition of the fingerprint or palmprint.

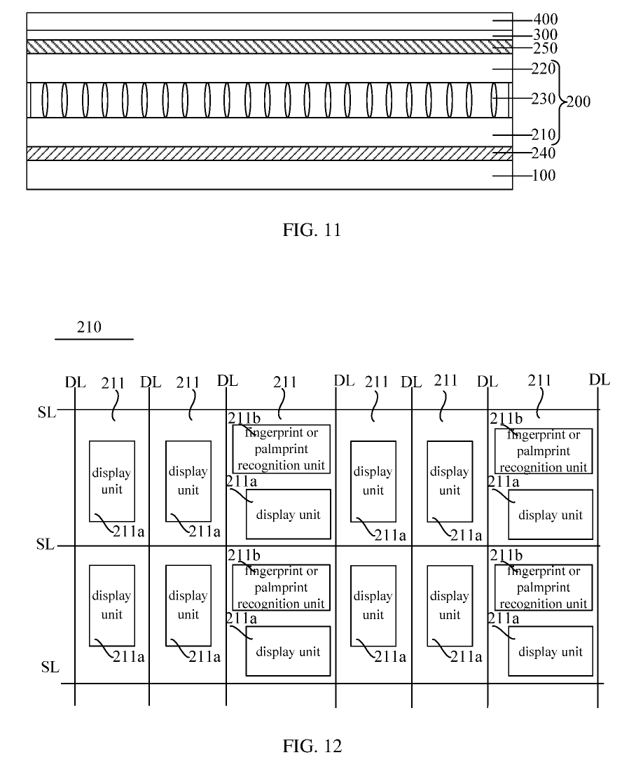

An embodiment of present disclosure also provides a display device, which comprises a liquid crystal display panel 200 and the above backlight module 100, as illustrated in FIG. 11. The liquid crystal display panel comprises a fingerprint or palmprint recognition unit (not illustrated in FIG. 11) integrated in the sub-pixels; the fingerprint or palmprint recognition unit comprises a photosensitive device or component.

Based on this, the display device may further comprise a lower polarizer sheet 240 and an upper polarizer sheet 250, and the safety glass 400 may be bonded with the upper polarizer sheet 250 by means of Optically Clear Adhesive (OCA), for example.

It should be noted that the arrangement mode of the fingerprint or palmprint recognition unit may be selected according to the distance between adjacent ridge lines and the distance between adjacent valley lines in the fingerprint or palmprint, for example, one fingerprint or palmprint recognition unit may be arranged at an interval of several sub-pixels.

Furthermore, the frequency of the inputted AC voltage is associated with the scanning frequency of the fingerprint or palmprint.

With an embodiment of present disclosure, because the noise outputted from the backlight can be reduced, it is thus possible to depress the current fluctuation caused by the noise in the recognition process of the valley lines and ridge lines, and to improve the accuracy of recognition of the fingerprint or palmprint.

In one embodiment as illustrated in FIG. 11, the liquid crystal display panel 200 comprises an array substrate 210, a cell-assembling substrate 220, and a liquid crystal layer 230 located therebetween.

As illustrated in FIG. 12, the scan lines SL and data lines DL in the array substrate 210 intersect with each other such that a plurality of sub-pixels are defined, each of the sub-pixels 211 may comprise a display unit 211a. Based on this, the fingerprint or palmprint recognition unit 211b may be arranged in the sub-pixels 211 at a predetermined interval; the fingerprint or palmprint recognition unit 211b comprises a photosensitive device, which may be a phototransistor or a photodiode, for example.

By taking into consideration that the spacing between ridge lines in the palmprint is greater than 100 μm, the spacing between valley lines is greater than the spacing between ridge lines, and the side length of the pixel in the array substrate 210 is generally controlled between 50 μm and 90 μm, it can be seen that the size of the pixel is significantly smaller than the spacing between the valley and the ridge. Hence, as illustrated in FIG. 12, an embodiment of present disclosure preferably allows one of the sub-pixels 211 in each pixel to include a fingerprint or palmprint recognition unit 211b.

The display unit 211a may comprise a thin film transistor which comprises a gate electrode, a gate insulating layer, a semiconductor active layer, a source electrode and a drain electrode, and a pixel electrode connected with the drain electrode. When the cell-assembling substrate does not comprise a common electrode, the array substrate 210 further comprises a common electrode. In such a case, as for the array substrate of In-Plane Switch type, the pixel electrode and the common electrode are arranged at an interval in the same layer, and are both strip-shaped electrodes; and as for the array substrate of Advanced-super Dimensional Switching type, the pixel electrode and the common electrode are arranged at different layers, and the upper electrode is the strip-shaped electrode, while the lower electrode is the plate-shaped electrode.

The cell-assembling substrate 220 comprises a color filter layer and a black matrix, and may further comprise a common electrode; the color filter layer comprises filter patterns of three primary colors arranged in three sub-pixels, respectively, for example, the red filtering pattern, the green filtering pattern and the blue filtering pattern.

It should be noted that FIG. 12 merely schematically illustrates that the array substrate 210 comprises the display unit 211a and the fingerprint or palmprint recognition unit, but does not show the signal lines and connection relationships that makes the two kinds of components operate.

For example, the display device may further comprise a touch sensing structure. In this way, the display device not only has the display function, but also has the fingerprint or palmprint recognition function.

The touch sensing structure comprises a touch electrode and a touch electrode line. The touch sensing structure may be located on the array substrate, or may also be above the upper polarizer sheet 250, as long as the touch function can be achieved, the embodiments of present disclosure are not limited to the specific locating position of the touch sensing structure.

Based on the above, the liquid crystal display of the embodiment of the present disclosure may be a liquid crystal television, a digital photo frame, a mobile phone, a tablet, or the products or components having any display functions.

The ordinary skilled in this art would appreciate that all or part of the steps of the above method embodiments may be performed by hardware in connection with program instructions, the aforesaid program may be stored in a computer readable storage medium, and such a program, when being executed, can carry out steps comprising the above method embodiments; and the aforesaid storage medium comprises ROM, RAM, disk or compact disk, and similar mediums that can store program code.

What are described above is related to the illustrative embodiments of the disclosure only and not limitative to the scope of the disclosure; the scopes of the disclosure are defined by the accompanying claims.

The application claims priority to the Chinese patent application No. 201610005446.2, filed Jan. 4, 2016, the entire disclosure of which is incorporated herein by reference as part of the present application.

1. A method for modulating a backlight source, comprising:
inputting a periodic AC voltage to the backlight source within the time period of an image frame, so that the backlight source is periodically turned on and off.

2. The method according to claim 1, wherein the time period of an image frame comprises a first time phase and a second time phase, and the method further comprises:
in the first time phase, inputting the periodic AC voltage to the backlight source;
in the second time phase, inputting a constant voltage to the backlight source so as to turn off the backlight source.

3. The method according to claim 1, wherein the periodic AC voltage comprises a pulse voltage or a sinusoidal voltage.

4. The method according to claim 3, wherein the pulse voltage comprises a square-wave pulse voltage or a saw-tooth pulse voltage.

5. A device for modulating a backlight source, comprising a voltage generation module and a control module, wherein,
the voltage generation module is configured to generate a periodic AC voltage within a time period of an image frame;
the control module is configured to input the AC voltage generated by the voltage generation module into the backlight source, in order to control the backlight source to be periodically turned on and off.

6. The device for modulating the backlight source according to claim 5, wherein the time period of an image frame comprises a first time phase and a second time phase;
the voltage generation module is configured to generate the periodic AC voltage in the first time phase, and to generate a constant voltage in the second time phase, in order to turn off the backlight source.

7. The device for modulating the backlight source according to claim 5, wherein the periodic AC voltage comprises a pulse voltage or a sinusoidal voltage.

8. A light bar comprising:
a circuit board;
a backlight source provided on the circuit board; and
the device for modulating a backlight source according to claim 5;
wherein the device for modulating the backlight source is integrally provided onto the circuit board.

9. A backlight module comprising the light bar of claim 8.

10. A display device comprising a liquid crystal display panel and a backlight module that is the backlight module according to claim 9;
wherein the liquid crystal display panel comprises a fingerprint or palmprint recognition unit integrated in the sub-pixels; and
the fingerprint or palmprint recognition unit comprises a photosensitive device.

11. The display device according to claim 10, further comprising a touch sensing structure.

12. The method according to claim 2, wherein the periodic AC voltage comprises a pulse voltage or a sinusoidal voltage.

13. The method according to claim 12, wherein the pulse voltage comprises a square-wave pulse voltage or a saw-tooth pulse voltage.

14. The device for modulating the backlight source according to claim 6, wherein the periodic AC voltage comprises a pulse voltage or a sinusoidal voltage.

15. The light bar according to claim 8, wherein the time period of an image frame comprises a first time phase and a second time phase;
the voltage generation module is configured to generate the periodic AC voltage in the first time phase, and to generate a constant voltage in the second time phase, in order to turn off the backlight source.

16. The light bar according to claim 15, wherein the periodic AC voltage comprises a pulse voltage or a sinusoidal voltage.
